(19) United States
(12) Patent Application Publication
(10) Pub. No.: US 2020/0049522 A1
(43) Pub. Date: Feb. 13, 2020

(54) METHODS AND SYSTEMS FOR ROUTE PLANNING

(71) Applicant: BEIJING DIDI INFINITY TECHNOLOGY AND DEVELOPMENT CO., LTD., Beijing (CN)

(72) Inventors: Zheng WANG, Beijing (CN); Yaxu LI, Beijing (CN); Rui PAN, Beijing (CN)

(73) Assignee: BEIJING DIDI INFINITY TECHNOLOGY AND DEVELOPMENT CO., LTD., Beijing (CN)

(21) Appl. No.: 16/656,690

(22) Filed: Oct. 18, 2019

Related U.S. Application Data
(63) Continuation of application No. PCT/CN2017/088084, filed on Jun. 13, 2017.

(51) Int. Cl. G01C 21/34

(52) U.S. Cl. CPC G01C 21/3446; G01C 21/3453

(57) ABSTRACT

The present disclosure relates to a method and system for route planning based on a pre-calculated table of routes. The method includes receiving information including a start location and a destination from a user equipment via a network and accessing a database to obtain a table including a plurality of locations and a plurality of routes. The table is generated based on the locations, historical orders, route planning algorithms and distance thresholds. The method may also include generating a target route from the start location to the destination based on the table.

### CROSS-REFERENCE TO RELATED APPLICATION

This application is a Continuation of International Application No. PCT/CN2017/088084, filed on Jun. 13, 2017, the entire content of which is hereby incorporated by reference.

### TECHNICAL FIELD

This present disclosure generally relates to methods and systems for route planning, and more particularly, to methods and systems for route planning based on a pre-calculated table of routes.

### BACKGROUND

Digital navigation has become increasingly popular. Current navigation application generally recommends a route for a user from his or her start location to a destination. The current method may include calculating some possible routes between the start location and the destination. Then one or more routes may be selected from the possible routes. However, when a massive number of routes are calculated simultaneously, the route planning may become slow.

### SUMMARY

In one aspect of the present disclosure, a system is provided. The system may include a storage device storing a set of instructions and at least one processor configured to communicate with the storage device. When executing the set of instructions, the at least one processor is configured to cause the system to receive information including a start location and a destination from a user equipment via a network and access a database to obtain a table including a plurality of locations and a plurality of routes. The at least one processor is further configured to generate a target route from the start location to the destination based on the table.

In another aspect of the present disclosure, a method is provided. The method may be implemented on at least one device including at least one processor and a storage. The method may include receiving information including a start location and a destination from a user equipment via a network. The method may also include accessing a database to obtain a table including a plurality of routes, locations and a plurality of routes. The method further includes generating a target route from the start location to the destination based on the table.

In yet another aspect of the present disclosure, a non-transitory computer readable medium is provided. The computer readable medium may include executable instructions that, when executed by at least one processor of an electronic device, direct the at least one processor to perform actions of receiving information including a start location and a destination from a user equipment via a network and accessing a database to obtain a table, the table including a plurality of locations and a plurality of routes. The instructions further cause the at least one processor to generate a target route from the start location to the destination based on the table.

In some embodiments, the table is generated according to a process of generating a table including a plurality of locations The process may include obtaining a plurality of first locations; determining a plurality of routes relating to the plurality of first locations; determining a plurality of second locations that each of the plurality of routes passes through; and generating the table, the table including the plurality of first locations, the plurality of routes, and the plurality of second locations.

In some embodiments, the process of generating the table may further include obtaining a plurality of historical orders; and obtaining the plurality of first locations and the plurality of routes based on the historical orders.

In some embodiments, the determining the plurality of routes relating to the plurality of first locations may include generating, based on the plurality of first locations, the plurality of routes by a route planning algorithm.

In some embodiments, the route planning algorithm may include one of Dijkstra algorithm, Floyd-Warshall algorithm, or Bellman-Ford algorithm.

In some embodiments, the determining a plurality of routes relating to the plurality of first locations may include obtaining a distance threshold; determining a plurality of pairs of the first locations, a distance between two locations of each of the pairs of locations being less than the distance threshold; designating first locations of at least one pair of the plurality of pairs of the first locations as a start point and an end point; and determining the plurality of routes relating to the plurality of first locations, the plurality of routes including a route from the start point to the end point.

In some embodiments, the process of generating the table may further include obtaining a sequence of the plurality of second locations on each route; and generating the table by arranging the plurality of second locations under the sequence.

In some embodiments, the accessing the database to obtain the table may include accessing the database, the database including a first table and a second table; determining a real-time condition, wherein the real-time condition is associated with a time of receiving the information including the start location and the destination; and selecting a table from the first table and the second table as the obtained table according to a real-time condition.

In some embodiments, one of the first table or second tables is generated according to a process. The process includes obtaining a plurality of first locations; determining a plurality of routes relating to the plurality of first locations under a condition; determining a plurality of second locations that the plurality of routes pass through; and generating the table including the plurality of first locations, the plurality of routes, and the plurality of second locations.

In some embodiments, the determining the target route from the start location to the destination may be generated based on characteristic information related to one or more routes of the plurality of routes, the one or more routes including the start location or the destination.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram of an exemplary route planning system according to some embodiments of the present disclosure;

FIG. 2 illustrates a block diagram of an exemplary computing device that is configured to implement a specific system disclosed in the present disclosure;

FIG. 3 illustrates a block diagram of an exemplary a mobile device that is configured to implement a specific system disclosed in the present disclosure;

FIG. 4 is a flowchart illustrating an exemplary process for route planning according to some embodiments of the present disclosure;

FIG. 5 is a flowchart of an exemplary process for generating a route table according to some embodiments of the present disclosure;

FIG. 6 is a flowchart of an exemplary process for generating a route based on a plurality of groups of routes according to some embodiments of the present disclosure;

FIG. 7 is a flowchart of an exemplary process for route planning according to some embodiments of the present disclosure;

FIG. 8 is a schematic diagram illustrating a structure of an exemplary route table according to some embodiments of the present disclosure;

FIG. 9A and FIG. 9B are schematic diagrams illustrating route planning according to some embodiments of the present disclosure; and

FIG. 10 is a schematic diagram illustrating an exemplary route planning according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

It will be understood that the term “system,” “engine,” “unit,” “module,” and/or “block” used herein are one method to distinguish different components, elements, parts, section or assembly of different level in ascending order. However, the terms may be displaced by another expression if they may achieve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

The system or method of the present disclosure may be applied to route planning systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof.

The term “passenger,” “requester,” “service requester,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger,” “user equipment,” “user terminal,” and “passenger terminal” may be used interchangeably, and “driver” and “driver terminal” may be used interchangeably.

The term “service request” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

An aspect of the present disclosure relates to a method of route planning. The method may be implemented by one or more components in a route planning system (e.g., server, user equipment, and driver terminal). The method includes generating a target route from a start location to a destination based on a route table including a plurality of locations and a plurality of routes. In some embodiments, the route table may also include safety information, price information, road information, etc. The server may receive information including the start location and destination from the user equipment and/or driver terminal. The start location may be a current location of a service provider (e.g., a driver, a deliveryman), and the destination may be a current location of an order or a service requester (e.g., a passenger, a customer). The server then access a database to obtain the route table. The server may obtain the plurality of locations and the plurality of routes in the route table based on historical data, route planning algorithm, and/or real-time conditions. The real-time conditions may include weather condition, traffic condition, and event condition at the time that a service request is made In order to reduce computation load, the server may only generate the routes that are within a distance threshold and store them in the route table. The distance threshold may relate to the number of locations in the route table, the number of users (e.g., drivers, passengers) determined or estimated from historical data, the number of users (e.g., drivers, passengers) determined or estimated based on real-time conditions, the number of current orders or historical orders, etc. The server may generate the target route from the start location to the destination based on the plurality of routes. In some embodiments, the server may first obtain one or more routes from the plurality of routes based on the real-time conditions. The server may then obtain the target route based on characteristic information. The characteristic information may include information related to the start location and/or the destination, the estimated time of arrival (ETA) from the start location to the destination, region information (e.g., the traffic in the region where the start location and/or the destination locate), time information, user information (e.g., passenger preferences) or service request information.

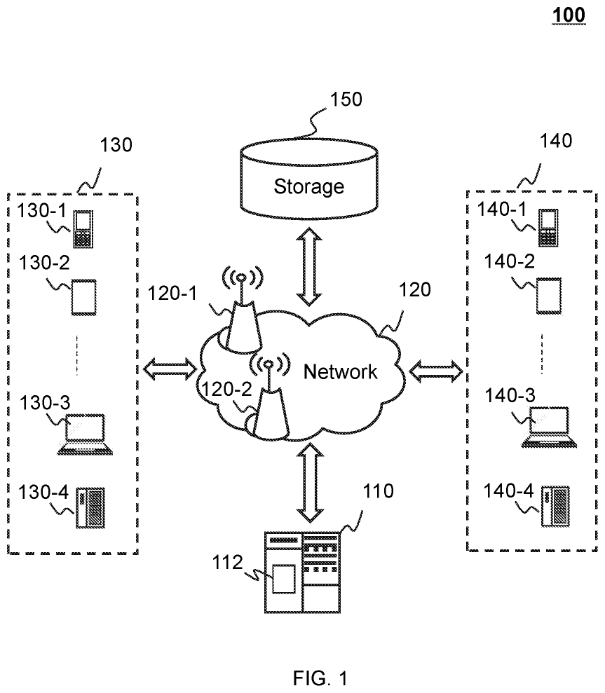

FIG. 1 is a block diagram of an exemplary route planning system 100 according to some embodiments of the present disclosure. As shown in FIG. 1, the route planning system 100 may include a server 110, a network 120, a user equipment 130, a driver terminal 140, and a storage 150. For example, the route planning system 100 may be used for transportation services such as taxi hailing, chauffeur service, express car, carpool, bus service, driver hire, shuttle service, delivery service, etc.

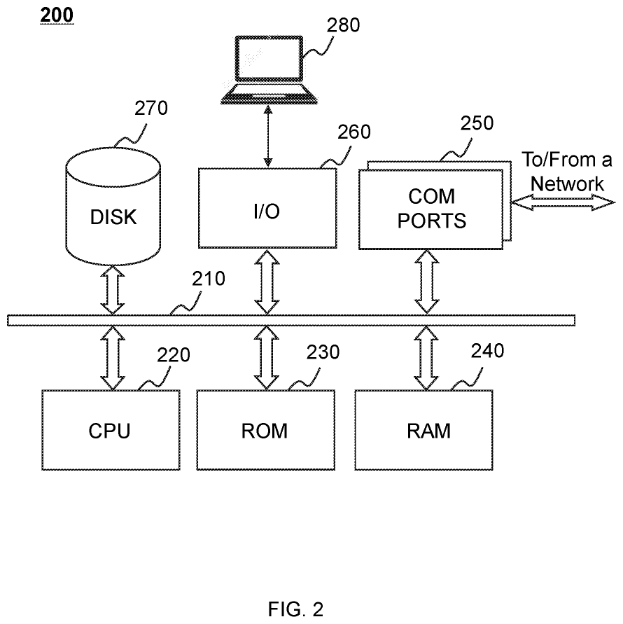

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the user equipment 130, the driver terminal 140, and/or the storage 150 via the network 120. As another example, the server 110 may connect directly to the user equipment 130, the driver terminal 140, and/or the storage 150 to access stored information and/or data. In some embodiments, the server 110 may be implemented on a cloud platform. The cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 illustrated in FIG. 2.

In some embodiments, the server 110 may include a processing engine 112. The processing engine 112 may process information and/or data relating to the service request to perform one or more functions described in the present disclosure. For example, the processing engine 112 may generate a plurality of routes relating to a plurality of locations based on historical data and/or route planning algorithm. As another example, the processing engine 112 may rank a plurality of locations of historical orders by popularity (e.g., the number of visits to a particular location, the number of historical orders associated with a particular location, the time lengths of stays at a particular location), and the plurality of locations may be obtained based on the ranking results. In some embodiments, the processing engine 112 may include one or more processing engines (e.g., single-core processing engine(s) or multi-core processor(s)). The processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the route planning system 100 (e.g., the server 110, the user equipment 130, the driver terminal 140, and the storage 150) may send information and/or data to another component(s) in the route planning system 100 via the network 120. For example, the server 110 may obtain/acquire service request from the user equipment 130 via the network 120. In some embodiments, the network 120 may be any type of wired or wireless network, or any combination thereof. The network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the route planning 100 may be connected to the network 120 to exchange data and/or information.

In some embodiments, a service requester may be a user of the user equipment 130. In some embodiments, the user of the user equipment 130 may be someone other than the service requester. For example, user A of the user equipment 130 may use the user equipment 130 to send a service request for user B, or receive service and/or information or instructions from the server 110. In some embodiments, a service provider may be a user of the driver terminal 140. In some embodiments, the user of the driver terminal 140 may be someone other than the service provider. For example, user C of the driver terminal 140 may user the driver terminal 140 to receive a service request for user D, and/or information or instructions from the server 110.

The user equipment 130 may be configured to receive an input of information including a start location and/or a destination from a user. Alternatively or additionally, the user equipment 130 may receive an instruction form the server 110 to obtain the information including the start location and/or the destination. In some embodiments, the user equipment 130 may select a target route from a plurality of routes between the start location and the destination in the route table based on characteristic information. The characteristic information may include information related to the start location and/or the destination, the Estimated Time of Arrival (ETA) from the start location to the destination, region information (e.g., the traffic in the region where the start location and/or the destination locate), time information, user information (e.g., passenger preferences) or service request information.

In some embodiments, the user equipment 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, a built-in device in the motor vehicle 130-4 may include an onboard computer, an onboard television, etc. In some embodiments, the user equipment 130 may be a device with positioning technology for locating the location of the service requester and/or the user equipment 130.

In some embodiments, the driver terminal 140 may be a device with positioning technology for locating the location of the driver and/or the driver terminal 140. In some embodiments, the user equipment 130 and/or the driver terminal 140 may communicate with other positioning device to determine the location of the service requester, the user equipment 130, the driver, and/or the driver terminal 140. In some embodiments, the user equipment 130 and/or the driver terminal 140 may send positioning information to the server 110.

The driver terminal 140 may be configured to receive an input of information including a start location (e.g., current location of a driver) from a driver. Alternatively or additionally, the driver terminal 140 may receive an instruction from the server 110 to obtain the information including the start location. In some embodiments, the driver terminal 140 may select a target route from a plurality of routes between the start location and the destination in the route table based on characteristic information. The characteristic information may include information related to the start location and/or the destination, the Estimated Time of Arrival (ETA) from the start location to the destination, region information (e.g., the traffic in the region where the start location and/or the destination locate), time information, user information (e.g., passenger preferences) or service request information.

The storage 150 may store data and/or instructions. In some embodiments, the storage 150 may store data obtained from the user equipment 130 and/or the driver terminal 140. In some embodiments, the storage 150 may store data and/or instructions that the server 110 may execute or use to perform exemplary methods described in the present disclosure. For example, the storage 150 may be configured to store historical data. The historical data may include start locations and destinations included in historical orders, historical locations of drivers or passengers, historical locations that passengers or drivers stayed at, etc. As another example, the storage 150 may be configured to store the route table for route planning. The route table may include locations, routes, route distances and sequence information. In some embodiments, the route table may also include safety information (e.g., road width, traffic lights, speed), price information (e.g., toll station, fuel consumption), road information (road types, road width, traffic lights, traffic control, road congestion) or the like, or any combination thereof.

In some embodiments, storage 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components in the route planning system 100 (e.g., the server 110, the user equipment 130, the driver terminal 140). One or more components in the route planning system 100 may access the data and/or instructions stored in the storage 150 via the network 120. In some embodiments, the storage 150 may be directly connected to or communicate with one or more components in the route planning system 100 (e.g., the server 110, the user equipment 130, the driver terminal 140). In some embodiments, the storage 150 may be part of the server 110.

In some embodiments, one or more components in the route planning system 100 (e.g., the server 110, the user equipment 130, the driver terminal 140) may access the storage 150. In some embodiments, one or more components in the route planning system 100 may read and/or modify information relating to the service requester, driver, and/or the public when one or more conditions are met. For example, the server 110 may read and/or modify one or more users' information after a service. As another example, the driver terminal 140 may access information relating to the service requester when receiving a service request from the user equipment 130, but the driver terminal 140 may not modify the relevant information of the service requester.

In some embodiments, information exchanging of one or more components of the route planning system 100 may be achieved by way of requesting a service. The object of the service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

FIG. 2 illustrates a block diagram of an exemplary computing device that is configured to implement a specific system disclosed in the present disclosure (e.g., the server 110). The particular system may use a functional block diagram to explain the hardware platform containing one or more user interfaces. The computer may be a computer with general or specific functions. Both types of the computers may be configured to implement any particular system according to some embodiments of the present disclosure. The computing device 200 may be configured to implement any components that provide information required by the route planning disclosed in the present description. For example, the server 110 may be implemented by hardware devices, software programs, firmware, or any combination thereof of a computer like the computing device 200. Merely by way of example, the computing device 200 that is configured to implement the server 110 may generate a plurality of routes relating to the plurality of locations based on the historical orders and/or route planning algorithm. As another example, the computing device 200 may rank a plurality of locations of historical orders by popularity (e.g., the number of visits to a particular location, the number of historical orders associated with a particular location, the time lengths of stays at a particular location), and the plurality of locations may be obtained based on the ranking results. For brevity, FIG. 2 depicts only one computer. In some embodiments, the functions of the computer, providing information that route planning may require, may be implemented by a group of similar platforms in a distributed mode to disperse the processing load of the system.

The computing device 200 may include a communication terminal 250 that may connect with a network that may implement the data communication. The computing device 200 may also include a CPU that is configured to execute instructions and includes one or more processors. The schematic computer platform may include an internal communication bus 210, different types of program storage units and data storage units, e.g. a hard disk 270, a ROM 230, a RAM 240), various data files applicable to computer processing and/or communication, and some program instructions executed possibly by the CPU. The computing device 200 may also include an I/O device 260 that may support the input and output of data flows between the computer and other components (e.g. a user interface 280). Moreover, the computing device 200 may receive programs and data via the communication network.

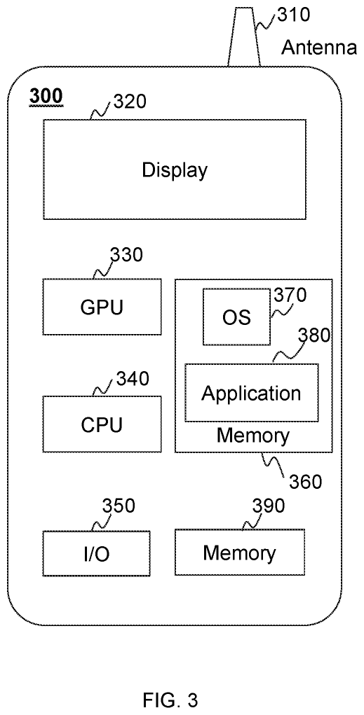

FIG. 3 illustrates a block diagram of an exemplary mobile device that is configured to implement a specific system disclosed in the present disclosure (e.g., the user equipment 130 and/or the driver terminal 140). In some embodiments, the user equipment 130 and/or the driver terminal 140 configured to display and communicate information related to locations may be a mobile device 300. The mobile device 300 may include but is not limited to a smartphone, a tablet computer, a music player, a portable game console, a GPS receiver, a wearable calculating device (e.g. glasses, watches.), etc. The mobile device 300 may include one or more CPUs 340, one or more GPUs 330, a display 320, a memory 360, an antenna 310 (e.g. a wireless communication unit), a storage unit 390, and one or more input/output (I/O) devices 350. Moreover, the mobile device 300 may also be any other suitable component that includes but is not limited to a system bus or a controller (not shown in FIG. 3). As shown in FIG. 3, a mobile operating system 370 (e.g. 10S, Android, Windows Phone) and one or more applications 380 may be loaded from the storage unit 390 to the memory 360 and implemented by the CPUs 340. The application 380 may include a browser or other mobile applications configured to receive and process information related to locations in the mobile device 300.

In order to implement various modules, units and their functions described above, a computer hardware platform may be used as hardware platforms of one or more elements (e.g., the server 110 and/or other sections of the system 100 described in FIG. 1). Since these hardware elements, operating systems and program languages are common; it may be assumed that persons skilled in the art may be familiar with these techniques and they may be able to provide information required in the route planning according to the techniques described in the present disclosure. A computer with the user interface may be used as a personal computer (PC), or other types of workstations or terminal devices. After being properly programmed, a computer with the user interface may be used as a server. It may be considered that those skilled in the art may also be familiar with such structures, programs, or general operations of this type of computer device. Thus, extra explanations are not described for the Figures.

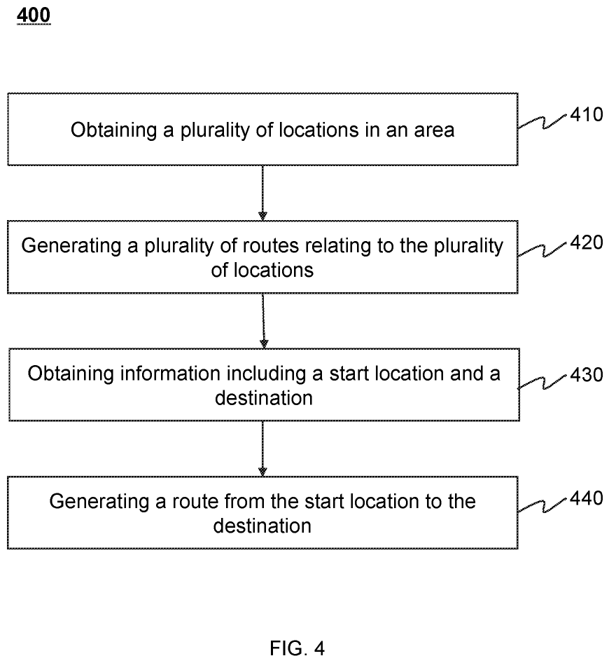

FIG. 4 is a flowchart illustrating an exemplary process of route planning according to some embodiments of the present disclosure. The process 400 may be executed by a device in the route planning system 100 (e.g., the server 110, user equipment 130, and driver terminal 140). For example, the process 400 may be implemented as a set of instructions (e.g., an application) stored in a storage medium.

In 410, the server 110 may obtain a plurality of locations in an area. The plurality of locations may each correspond to one or more objects including buildings, rivers, bridges, roads, persons, sceneries, landmarks, or the like, or any combination thereof. Merely by way of example, a location may correspond to an entrance, an exit, a center point, of the one or more objects. For example, a location of a residential area may be its entrance or exit. As another example, a location of a road may be its start point, end point, center point, or intersection points. In some embodiments, only a preset number (e.g. one, two, three) of locations may be obtained in 410 with respect to an object. For example, only two locations (e.g. front and back gate) of a zoo may be obtained in 410. In some embodiments, the plurality of locations may each include a physical address, and the physical address may include a latitude and a longitude or a relative position corresponding to a reference location. Alternatively or additionally, the location may include one or more POIs associated with an address or a point in a map. The area may be a block, a road, a district, a town, a city, a province, etc. The plurality of locations may be obtained based on historical data. For example, the server 110 may obtained one or more historical orders and obtain a plurality of locations from the received historical orders, including, for example, the start locations and destinations included in the historical order(s), historical locations that users searched for or entered, historical locations of drivers or passengers, historical locations that passengers or drivers stayed at, etc. The historical data may be obtained from storage 150. In some embodiments, the objects and their corresponding locations in the area may be obtained in 410. Alternatively or additionally, the locations in the area may first be ranked based on their popularity (e.g., the number of visits to a particular location, the number of historical orders associated with a particular location, the time lengths of stays at a particular location). Some of the locations may then be obtained in 410 based on the ranking result. In some embodiments, the plurality of locations may be inputted by a user via the user equipment 130 or obtained from the storage 150.

In 420, the server 110 may generate a plurality of routes relating to the plurality of locations. In some embodiments, the plurality of routes may be generated according to historical data. For example, the server 110 may obtain, from the storage 150, historical orders that include some or all of the plurality of locations and the routes corresponding to these historical orders. In some embodiments, all the routes of these historical orders may be obtained. Alternatively or additionally, only the routes (or segment of routes) between the some or all of the plurality of locations may be obtained.

In some embodiments, the plurality of routes may be generated based on the plurality of locations by one or more route planning algorithms. The route planning algorithms may include but are not limited to Dijkstra algorithm, Floyd-Warshall algorithm, or Bellman-Ford algorithm. For example, with respect to two locations (of the plurality of locations), multiple possible routes between the two locations may first be generated. Then one or more of the multiple routes may be selected based on a route condition. The route condition may include a safest route, a shortest route, a route with most sceneries, a route with less traffic, etc. For example, the shortest route may be determined based on the distance of the route between the start location and the destination. In some embodiments, the server 110 may obtain extra parameters corresponding to the route condition. For example, the safest route may be determined based on extra parameters such as road type, road width, traffic condition, speed limit, curve radius, number of intersections, etc. Merely by way of example, the safest route may be a highway with few intersections and traffics.

In some embodiments, the plurality of routes may be stored in a table, a list, a database, a graph, an animation, a flash, etc. In some embodiments, all of the plurality of routes generated in 420 may be stored. Alternatively or additionally, for each two of the locations, the shortest route (and/or the safest route, the route with most sceneries or the route with least traffic) between them may be stored. In some embodiments, the route table may be stored in a format of lossless compression.

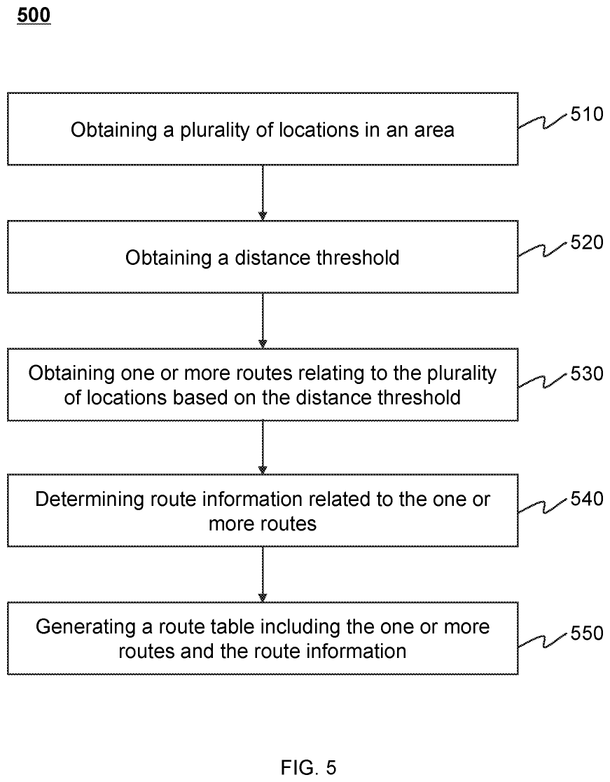

In some embodiments, more information related to the plurality routes may also generated. For example, the plurality of routes may be stored in a format of a graph or animation, the routes may be stored (and displayed) as graphical information. For example, the graphical information may include a 2-Dimensional or 3-Dimensional curve or shape connecting the start location and the destination shown in a digital map. As another example, the plurality of routes may be stored in a table, a list, or a database, the locations or points in the routes and the corresponding sequence of the locations or points may also be generated and stored. For example, a table may include the start location and destination of each of the plurality of routes. It may also include one or more locations that each of the plurality of routes passes through and the sequence of the one or more locations. Moreover, the table may include a distance of each of the plurality of routes. The distance may include straight-line distance, actual distance, road distance, etc. Alternatively or additionally, the table may further include the estimated time of arrival (ETA) from a location to another location. Detailed description of generation of the table can be found elsewhere in this disclosure (e.g., in connection with FIG. 5).

In some embodiments, a plurality of groups of routes may be generated based on different real-time conditions. The real-time conditions may be associated with a time of receiving the start location and the destination. In some embodiments, the real-time conditions may include weather condition, traffic condition, and event condition at the time that a service request is made (historical or current service request or order). Routes from the different groups may have same or different start locations or destinations. For example, the plurality of routes may be generated (or determined) based on historical data (e.g. historical orders), and the server 110 may first determine the then real-time conditions of the historical orders. The historical orders with the same or similar real-time conditions may be classified into the same groups. The plurality of groups of routes may each be generated based on a group of historical orders. For example, the plurality of routes are generated by route planning algorithms, the server 110 may first obtain parameters of the roads around the locations. The parameters may include road length, road width, road type, speed limit, traffic condition, number and locations of the intersections, etc. The server 110 may also obtain, calculate, or anticipate changes of parameters with respect to different real-time conditions. For example, the server 110 may anticipate an increase in the number of cars in rush hours, and the increase may cause a traffic congestion in roads that are both narrow and have heavy traffics. The server 110 may then decide not to include these types of roads in the generation of the group of routes which correspond to rush hours. The server 110 may perform the method described above repeatedly with different real-time conditions to generate a plurality of groups of routes that correspond to different real-time conditions. The different groups of routes may be stored in same or different tables. For example, a first group of routes corresponding to rainy days may be stored in a first table, and a second group of routes corresponding to sunny days may be stored in a second table. As another example, a third group of routes corresponding to rush hours may be stored in a third table and a fourth group of routes corresponding to normal hours may be stored in a fourth table. In some embodiments, different groups of routes may be stored in a same table but in different columns or rows.

In 430, the server 110 may obtain information including a start location and a destination. In some embodiments, the information including the start location and the destination may be inputted by a user via the user equipment 130 or driver terminal 140, which may be transmitted to the server 110 via the network 120. Alternatively or additionally, the server 110 may send an instruction to the user equipment 130 and/or the driver terminal 140 to obtain the information including the start location and the destination.

In some embodiments, the start location may be a current location of a service provider (e.g., a driver, a deliveryman), and the destination may be a current location of an order or a service requester (e.g., a passenger, a customer). In some embodiments, the start location may be a location where the driver picks up a passenger and the destination may be a location the passenger wants to go to. In some embodiments, the start location and the destination may be found in the table generated in 420 (i.e. the same as some of the locations in the table). In a case that the start location and/or the destination cannot be found in the table, one or more locations in the table that are close to the start location and/or the destination may be obtained as the start location and/or the destination.

In 440, the server 110 may generate a route from the start location to the destination. In some embodiments, the start location and the destination obtained in 430 may be the same as or similar to the start location and the destination of one or more of the plurality of routes in the table. In this case, a route similar to the one or more of the plurality of routes may be generated. In addition, a target route may be selected from the one or more routes based on characteristic information. The characteristic information may include information related to the start location and/or the destination, the Estimated Time of Arrival (ETA) from the start location to the destination, region information (e.g., the traffic in the region where the start location and/or the destination locate), time information, user information (e.g., passenger preferences) or service request information.

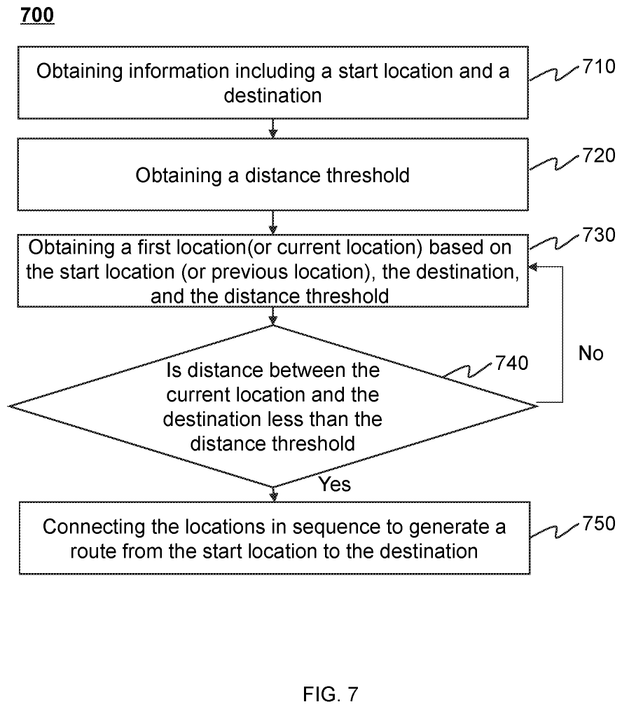

In some embodiments, the start location and the destination obtained in 430 may be found in the table but in different routes. In other words, the table may not include any route that directly goes from the start location to the destination. In this case, a route from the start location to the destination may be generated by combining multiple routes in the table. For example, A and B may be a start location and a destination of a service order, respectively. No route that goes directly from A to B can be found in the table. A route from A to C and a route from C to B can be located in the table. Then the server 110 may combine or connect the route from A to C and the route from C to B to generate a route from A to C. Detailed descriptions regarding the method of combining the plurality of routes may be found elsewhere in the present disclosure (e.g., FIG. 7 and the descriptions thereof).

It should be noted that the above descriptions of process 400 are provided for the purposes of illustration, and not intended to limit the scope of the present disclosure. For persons having ordinary skills in the art, various modifications and changes in the forms and details of the application of the above method and system may occur without departing from the principles in the present disclosure. In some embodiments, the order of the operations in process 400 may be changed. For example, a plurality of routes may first be obtained based on historical data in 420. Based on the plurality of routes, a plurality of locations may then be obtained in 410. The plurality of locations may include start locations, destinations, intersections, or other locations in the plurality of routes. As another example, 410 and 420 may be performed simultaneously, for example, a plurality of routes and a plurality of locations may be obtained simultaneously based on historical orders. However, those variations and modifications also fall within the scope of the present disclosure.

FIG. 5 is a flowchart of an exemplary process for generating a route table according to some embodiments of the present disclosure. The process 500 may be executed by a device in the route planning system 100 (e.g., the server 110, user equipment 130, and driver terminal 140). For example, the process 500 may be implemented as a set of instructions (e.g., an application) stored in a storage medium.

In 510, the server 110 may obtain a plurality of locations in an area. The plurality of locations may each correspond to one or more objects including buildings, rivers, bridges, roads, persons, sceneries, landmarks, or the like, or any combination thereof. In some embodiments, the plurality of locations may each include a physical address, and the physical address may include a latitude and a longitude or a relative position corresponding to a reference location. Alternatively or additionally, the location may include one or more Point of Interests (POIs) associated with an address or a point in a map. In some embodiments, the area may be a block, a road, a district, a town, a city, a province, etc. The plurality of locations may be obtained based on historical data. In some embodiments, the plurality of locations may be inputted by a user via the user equipment 130 or obtained from the storage 150. Detailed description of obtain a plurality of locations in an area by the server 110 may be found elsewhere in this disclosure (e.g., in connection with 410).

In 520, the server 110 may obtain a distance threshold. For any two locations of the plurality of locations, the server 110 may generate a route connecting these two locations that is shorter than the distance threshold. In some embodiments, the server 110 may first obtain a distance (e.g., straight line distance) between any two locations of the plurality of locations. The server 110 may compare the measured distance with the distance threshold to decide whether a route should be generated between the two locations. For example, the server 110 may generate a route connecting each two locations of the plurality of locations that are close. The term “close” may be referred to as that the distance between the two locations are less than the distance. In some embodiments, the distance threshold may be same or different for the locations. The distance threshold may relate to the number of locations in the table, the number of users (e.g., drivers, passengers) determined or estimated from historical data, the number of users (e.g., drivers, passengers) determined or estimated based on real-time conditions, the number of current orders or historical orders, etc. In some embodiments, the distance threshold may be a constant value, for example, 200 m, 500 m, 1 km, 3 km, 5 km, or 10 km. Alternatively or additionally, the distance threshold may be adjusted by the server 110 according to real-time conditions such as weather condition, traffic condition, and event condition at the time that a service request is made (historical or current service request or order).

The distance threshold may be preset by the route planning system 100 or by a user via a user equipment 130. In some embodiments, the distance threshold may be different in different areas. For example, in an area with a large number of locations (i.e. locations of the table obtained by the route planning system 100), the distance threshold may be relatively small so that the computation load is reduced. In an area with a small number of locations, the distance threshold may be large so that sufficient routes are generated. For example, in an area with thousands of drivers and orders, the distance threshold may be relatively small, for example, 2 km. As another example, in an area with hundreds of drivers and service orders, the distance threshold may be relatively large, for example, 6 km.

In some embodiments, 520 may be omitted. For any two locations of the plurality of locations in the area, the server 110 may generate a route connecting these two locations. For example, in an area with 10 drivers and 10 orders, one or more routes between any two of the locations (i.e., locations related to the 10 drivers and locations of 10 service orders) may be obtained according to historical data and/or route planning algorithm.

In 530, the server 110 may obtain one or more routes relating to the plurality of locations based on the distance threshold. For example, the server 110 may generate a plurality of routes relating to any two locations (also referred to as a pair of locations) of the plurality of locations. In some embodiments, the server 110 may designate a location of the two locations as a start point and another as an end point. The server may generate a route from the start point to the end point. The server 110 may select, from the plurality of routes relating to any two locations, one or more routes that are shorter than the distance threshold. In some embodiments, the server 110 may first obtain a distance (e.g., the straight line distance) between any two locations of the plurality of locations. The server 110 may compare the measured distance with the distance threshold to decide whether a route should be generated between the two locations. For example, the server 110 may generate a route connecting each two locations of the plurality of locations that are close. The term “close” may be referred to as that the distance between the two locations are less than the distance. In some embodiments, the one or more routes may be generated according to historical data. For example, the server 110 may obtain, from the storage 150, historical orders that include some or all of the plurality of locations and the routes corresponding to these historical orders. In some embodiments, the server 110 may only obtain the routes (or segment of routes) between the some or all of the plurality of locations that are less than the distance threshold.

In some embodiments, the server 110 may generate one or more routes relating to the plurality of locations based on one or more route planning algorithms. The route planning algorithms may include Dijkstra algorithm, Floyd-Warshall algorithm, or Bellman-Ford algorithm. For example, with respect to two locations (of the plurality of locations), multiple possible routes between the two locations that are less than the distance threshold may first be generated. Then one or more of the multiple routes may be selected based on a route condition. The route condition may include a safest route, a shortest route, a route with most sceneries, a route with less traffic, etc. For example, the shortest route may be determined based on the distance of the route between the start location and the destination. In some embodiments, the server 110 may obtain extra parameters corresponding to the route condition. For example, the safest route may be determined based on extra parameters such as road type, road width, traffic condition, speed limit, curve radius, number of intersections, etc. Merely by way of example, the safest route may be a highway with few intersections and traffics.

In some embodiments, the server 110 may store the one or more routes in a table, a list, a database, a graph, an animation, a flash, etc. In some embodiments, the server 110 may store all of the one or more routes generated in 530. Alternatively or additionally, for each two of the locations, the shortest route (and/or the safest route, the route with most sceneries or the route with least traffic) between them may be stored.

In 540, the server 110 may determine route information related to the one or more routes. The route information may include one or more route distances and sequence information of the one or more routes. The route distance may be an actual distance that a vehicle moves from a location to another location. In some embodiments, methods of calculating the one or more route distances may include minimum-maximum normalization, Z-score normalization, standardization by decimal scaling, a linear function method, a logarithmic function method, an arc cotangent function method, a norm method, historical threshold iteration, a modeling method, a least square method, an elimination method, a reduced method, a substitution method, an image method, a comparison method, an amplification and minification method, a vector method, an inductive method, proof by contradiction, an exhaustive method, a method of completing the square, an undetermined coefficient method, a method of changing variables, methods of splitting terms, a method of adding terms, a factorization method, a translation method, a function approximation method, an interpolation method, a curve fitting method, an integral method, a differential method, a perturbation method, or the like, or any combination thereof.

The sequence information may include a sequence of locations that each of the one or more routes passes through. The locations may each include a description and a physical address. The description may include a name, a house number, and a building name, or the like, or any combination thereof. The address may include a latitude and a longitude or a relative positions corresponding to a reference location.

In 550, the server 110 may generate a route table including the one or more routes. The route table may further include the route information related to the one or more routes and/or the corresponding locations. For example, the route table may include the route distances and sequence information of the routes. The route table may also include safety information (e.g., road width, traffic lights, speed), price information (e.g., toll station, fuel consumption), road information (road types, road width, traffic lights, traffic control, road congestion), or the like, or any combination thereof. The server 110 may determine an estimated time of arrival (ETA) of each of the routes based on the road information (e.g., road types, traffic lights) and route distance. The server 110 may also store the ETA information into the table.

In some embodiments, the route table may further include multiple sections (e.g., multiple rows and columns) that correspond to different real-time conditions. The real-time conditions may be associated with a time of receiving the start location and the destination. In some embodiments, the real-time conditions may include weather condition (e.g., temperature, humidity), traffic condition (e.g., road information, traffic congestion, traffic control), event condition (e.g., holidays, important events) at the time that a service request is made (historical or current service request or order), or the like, or any combination thereof.

In some embodiments, the server 110 may generate a plurality of route tables based on different real-time conditions. For example, a first group of routes corresponding to rush hours may be stored in a first route table, and a second group of routes corresponding to normal hours may be stored in a second route table. In some embodiments, the plurality of route tables may have same or different locations. The plurality of route tables may be obtained based on historical data and/or route planning algorithm. For example, the plurality of routes may be generated (or determined) based on historical data (e.g. historical orders), and the server 110 may first determine the then real-time conditions of the historical orders. The historical orders with the same or similar real-time conditions may be classified into the same groups. The plurality of groups of routes may each be generated based on a group of historical orders. For example, the plurality of routes are generated by route planning algorithms, the server 110 may first obtain parameters of the roads around the locations. The parameters may include road length, road width, road type, speed limit, traffic condition, number and locations of the intersections, etc. The server 110 may also obtain, calculate, or anticipate changes of parameters with respect to different real-time conditions. For example, the server 110 may anticipate an increase in the number of cars in rush hours, and the increase may cause a traffic congestion in roads that are both narrow and have heavy traffics. The server 110 may then decide not to include these types of roads in the generation of the group of routes which correspond to rush hours. The server 110 may perform the method described above repeatedly with different real-time conditions to generate a plurality of groups of routes that correspond to different real-time conditions. For example, the first group of routes corresponding to rush hours may be obtained based on historical orders that were made in rush hours and the second group of routes corresponding to normal hours may be obtained based on historical orders that were made in normal hours. As another example, the server 110 may estimate or obtain change of parameters, (e.g., road length, road width, road type, speed limit, traffic condition, number and locations of the intersections) in rush hours and normal hours respectively. The server 110 may generate the first table which includes the first group of routes corresponding to rush hours based on the estimated change of parameters in rush hours. Similarly, the server 110 may generate the second table which includes the second group of routes corresponding to normal hours based on the estimated change of parameters in normal hours.

When a route from a start location to a destination is required under a real-time condition, the server 110 may select a corresponding table based on the real-time condition. For example, when an order or a service request is made during rush hours, the server 110 may select a route table corresponding to rush hours, and the server 110 may also select one or more routes relating to the start location and the destination of the order from the selected route table. In some embodiments, the server 110 may switch to other route tables based on the real-time condition. For example, during normal hours, the server 110 may switch to a route table corresponding to the normal hours, and the server 110 may also select one or more routes relating to the start location and the destination of the order from the route table switched to.

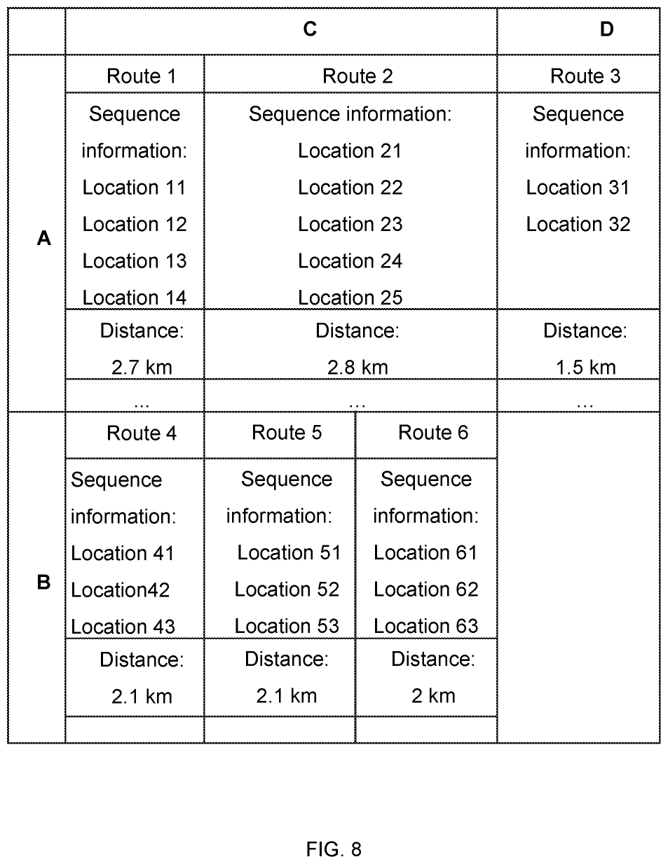

In some embodiments, the server 110 may generate the route table, and the storage 150 or the user equipment 130 may store the route table. For example, a distance threshold in Beijing may be set as 3 km. According to the routes in Beijing and the distance threshold, a route table may be generated. The route table may be stored in a format of a lossless compression that may be smaller than 10 gigabytes (GB). This may be an ideal size to be stored in a server, a computer, or a mobile device. For example, the route table may be stored in the user equipment 130, the route may be generated offline. When a route from the start location and destination of a user is required, the route table may be used directly and the route may be generated without calculation. An exemplary structure of the route table may be found in FIG. 8.

The server 110 may be a single server or a server group. In some embodiments, the server 110 may include a first server configured to generate a plurality of route tables and a second server configured to store the route tables and output a route from the plurality of route tables in response to a request from a user or a component in route planning system 100. In some embodiments, the second server may include one or more servers. For example, when a plurality of route tables are generated based on different real-time conditions, each of the plurality of route tables may be stored separately in the one or more servers. Alternatively or additionally, some or all of the route tables may be duplicated and stored in some or all of the one or more servers.

In some embodiments, a user may input information including a start location and destination on the user equipment 130 and/or driver terminal 140. The information including the start location and destination may be transmitted to the second server via the network 120. Then the second server may search the route table relating to the start location and destination, and one or more routes may be transmitted to the user by the second server via network 120. The one or more routes may have same start location and destination as the user input. In some embodiments, the user may further input characteristic information and the second server may transmit a target route (e.g., a safest route, a shortest route, a route with most sceneries, a route with less traffic) among the one or more routes based on the characteristic information. The characteristic information may include information related to the start location and/or the destination, the Estimated Time of Arrival (ETA) from the start location to the destination, region information (e.g., the traffic in the region where the start location and/or the destination locate), time information, user information (e.g., passenger preferences) or service request information.

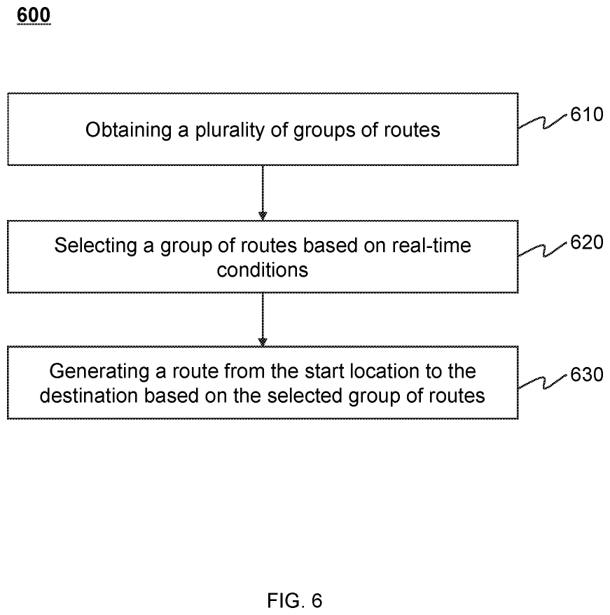

FIG. 6 is a flowchart of an exemplary process for generating a route based on a plurality of groups of routes according to some embodiments of the present disclosure. The process 600 may be executed by a device in the route planning system 100 (e.g., the sever 110, user equipment 130, driver terminal 130). For example, the process 600 may be implemented as a set of instructions (e.g., an application) stored in a storage medium.

In 610, the server 110 may obtain a plurality of groups of routes. For example, the server 110 may obtain a first group of routes and a second group of routes from storage 150 (or another server). The server 110 may generate the obtained groups of routes according to different conditions as described elsewhere in this disclosure (e.g., using the process 400 and/or process 500 described above). The conditions may include weather information (e.g., temperature, humidity), traffic information (e.g., road information, traffic congestion, traffic control), event information (e.g., holidays, important events), or the like, or any combination thereof. For example, a group of routes may correspond to routes in rainy days, and another group of routes may correspond to routes in sunny days. As another example, a group of routes may correspond to routes in rush hours, and another group of routes may correspond to routes in normal hours. The server 110 may store the plurality of groups of routes in multiple tables or multiple columns or rows of a route table.

In 620, the server 110 may select a group of routes based on real-time conditions. For example, if the server 110 obtains a route planning request (e.g., a taxi service request from a passenger) from a particular area where is rainy, the server 110 may select a group of routes from the route table that corresponds to rainy days. As another example, if the server 110 obtains a route planning request from a particular time period that is during rush hours, the server 110 may select a route table corresponding to rush hours. In some embodiments, the server 110 may switch route tables based on current time (e.g., the time that the server 110 searches the route table). For example, the server 110 may access two route tables, the first route table including the first group of routes associated with rush hours (e.g., 7-9 a.m. and 5-7 p.m.) and the second route table including the second group of routes associated with normal hours (i.e., the hours rather than the rush hours). Before the rush hours (e.g., 7-9 a.m.), the server 110 may use the second table for searching (or generating) a route in response to a request by a terminal device. During the rush hours (e.g., 7-9 a.m.), the server 110 may switch to the first route table. And after the rush hours, the server 110 may switch back to the second route table. In some embodiments, if the server 110 cannot find a group of routes corresponding to the real-time condition, a default group of routes may be selected. For example, the default group of routes may be a group of shortest routes that are determined based on the distance of the route between the start location and the destination.

In 630, the server 110 may generate a route from the start location to the destination based on the selected group of routes. In some embodiments, the start location and the destination may be the same as or similar to the start location and the destination of one or more of the plurality of routes in the route table. In this case, the server 110 may generate a route similar to the one or more of the plurality of routes. In addition, a target route may be selected from the one or more routes based on characteristic information. The characteristic information may include information related to the start location and/or the destination, the Estimated Time of Arrival (ETA) from the start location to the destination, region information (e.g., the traffic in the region where the start location and/or the destination locate), time information, user information (e.g., passenger preferences) or service request information.

In some embodiments, the start location and the destination may be found in the route table but in different routes. In other words, the route table may not include any route that directly goes from the start location to the destination. In this case, a route from the start location to the destination may be generated by combining multiple routes in the route table.

FIG. 7 is a flowchart of an exemplary process for route planning according to some embodiments of the present disclosure. The process 700 may be executed by a device in the route planning system 100 (e.g., the server 110, user equipment 130, and driver terminal 140). For example, the process 700 may be implemented as a set of instructions (e.g., an application) stored in a storage medium. In some embodiments, process 700 illustrates a method for route planning between a start location and a destination that are far from each other (e.g., the distance between the start location and destination is greater than the distance threshold).

In 710, the server 110 may obtain information including a start location and a destination. Similar to those disclosed in connection with 430 described above, the information including the start location and the destination may be inputted by a user via the user equipment 130 or driver terminal 140, which may be transmitted to the server 110 via the network 120. Alternatively or additionally, the server 110 may send an instruction to the user equipment 130 and/or the driver terminal 140 to obtain the information including the start location and the destination.

In some embodiments, the start location may be a current location of a service provider (e.g., a driver, a deliveryman) and the destination may be a current location of an order or a service requester (e.g., a passenger, a customer). In some embodiments, the start location may be a location where the driver picks up a passenger and the destination may be a location the passenger wants to go to. In some embodiments, the start location and the destination may be found in the route table generated in 420 (i.e. the same as some of the locations in the route table). In a case that the start location and/or the destination cannot be found in the route table, the server 110 may obtain one or more locations in the route table that are close to the start location and/or the destination as the start location and/or the destination.

In 720, the server 110 may obtain a distance threshold. Similar to those disclosed in 520, for any two locations of the plurality of locations, the server 110 may generate a route connecting these two locations that is shorter than the distance threshold. Alternatively or additionally, the server 110 may generate a route between any two locations of the plurality of locations that are close (e.g., the distance there between is less than the distance threshold). In some embodiments, the distance threshold may be the same or different for the locations. The distance threshold may relate to the number of locations in the route table, the number of users (e.g., drivers, passengers) determined or estimated from historical data, the number of users (e.g., drivers, passengers) determined or estimated based on real-time conditions, the number of current orders or historical orders, etc. In some embodiments, the distance threshold may be a constant value, for example, 200 m, 500 m, 1 km, 3 km, 5 km, or 10 km. Alternatively or additionally, the distance threshold may change according to real-time conditions such as weather condition, traffic condition and event condition at the time that a service request is made (historical or current service request or order).

The distance threshold may be preset by the route planning system 100, or be set by a user via a user equipment 130. In some embodiments, the distance threshold may be different in different areas. For example, in an area with a large number of locations (i.e. locations of the route table obtained by the route planning system 100), the distance threshold may be small so that the computation load is reduced. In an area with a small number of locations, the distance threshold may be large so that sufficient routes are generated. For example, in an area with thousands of drivers and thousands of orders, the distance threshold may be relatively small, e.g., 2 kilometers. As another example, in an area with one hundred drivers and one hundred orders, the distance threshold may be relatively large, e.g., 6 kilometers.

In some embodiments, 720 may be omitted. For example, in an area with few locations, a route between any two of the locations in the area may be generated. For example, in an area with 10 drivers and 10 orders, one or more routes between any two of the locations may be obtained according to historical data and/or route planning algorithm.

In 730, the server 110 may obtain a first location based on the start location, the destination and the distance threshold in the first iteration. The first location may be selected from a plurality of locations of the route table as described elsewhere in the present disclosure. In some embodiments, the server 110 may select the first location from the plurality of locations based on the distance between the start location (or the destinations) and the plurality of locations. In some embodiments, the server 110 may calculate angles between the vector from the start location to the destination and the vectors from the start locations to the plurality of locations. The first location may be determined based on both the angles and the distances. In subsequent iterations, a current location (location in the current iteration) may be generated based on the previous location (location in the previous iteration), the destination and the distance threshold. The method of obtaining the current location in subsequent iterations may be similar to the method of obtaining the first location and is not repeated.

In 740, the server 110 may judge whether the distance between the current location and the destination is less than the distance threshold. If the distance between the current location and the destination is less than the distance threshold, the process 700 may proceed to 750; otherwise, the process 700 may proceed back to 730.

In 750, the server 110 may connect the locations in sequence to generate a route from the start location to the destination. As any two locations in successive iterations are close to each other (e.g., the distance therein is less than the distance threshold), a route corresponding to each of the two locations in successive iterations may be generated. The method of the generating the routes may be found in, for example, operation 440. Then the server 110 may connect the generated routes in sequence to generate a final route from the start location to the destination.

FIG. 8 is a schematic diagram illustrating an exemplary structure of a route table according to some embodiments of the present disclosure. As shown in FIGS. 8, A, B, C, and D may represent four exemplary locations among a plurality of locations. Route 1 and Route 2 may be two different routes from A to C (or from C to A). Route 1 may pass Location 11, Location 12, Location 13, and Location 14 (also referred to as sequence information). The distance of Route 1 may be 2.7 km. Route 2 may pass Location 21, Location 22, Location 23, Location 24, and Location 25. The distance of Route 2 may be 2.8 km.

Similarly, Route 3 may be a route from A to D (or from D to A). Route 3 may pass Location 31 and Location 32. The distance of Route 3 may be 1.5 km. Route 4, Route 5, and Route 6 may be routes from B to C (or from C to B). The distances of Route 4, Route 5, and Route 6 may be 2.1 km, 2.1 km, and 2 km, respectively.

In some embodiments, a distance threshold may be 3 km. As an example, a route distance between B and D may be 3.5 km. Since the route distance is larger than a distance threshold, no route between B and D is selected and returned in the route table.

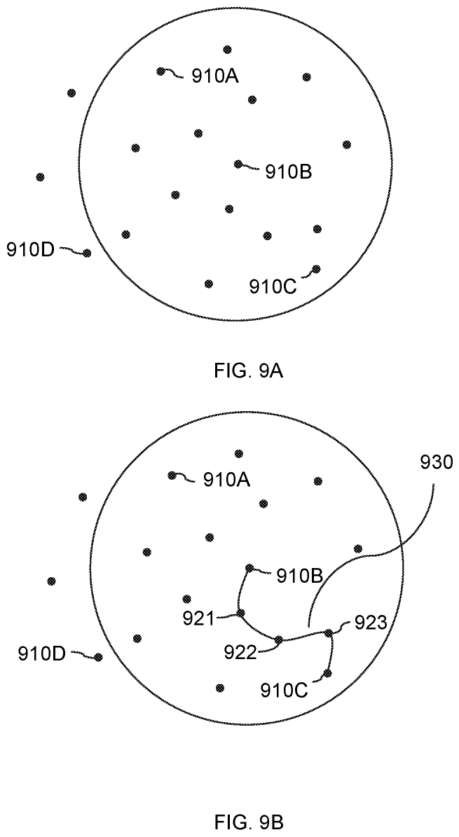

FIG. 9A and FIG. 9B are schematic diagrams illustrating route planning according to some embodiments of the present disclosure. In some embodiments, FIG. 9A and FIG. 9B are exemplary embodiments corresponding to the route table in FIG. 8, wherein 910A, 910B, 910C, and 910D correspond to Locations A, B, C, and D in the route table, respectively. The Route 930 may correspond to Route 4, and the 921, 922, and 923 may correspond to Locations 41, 42, and 43, respectively.

As shown in FIG. 9A, there are a plurality of locations, including Locations 910A, 910B, 910C, and 910D in the area (e.g., the exemplary circles shown in FIGS. 9A and 9B for illustration purpose only). The circle centered at Location 910B may have a radius equal to the distance threshold (e.g., 3 km, 5 km). In some embodiments, the plurality of locations may be obtained as described elsewhere in this disclosure. For those locations that are close to Location 910B (within the circle of threshold distance), such as Location 910A, Location 910C, etc., routes between Location 910B and the locations may be selected (or generated). For those locations that are far from Location 910B (outside the circle of threshold distance), such as Location 910D, the routes are not generated to reduce computational load. The locations and routes may be stored in form of a table (e.g. the route table in FIG. 8) in a storage device. In some embodiments, the server 110 may obtain information including a start location and a destination of the user from the user equipment 130 and/or driver terminal 140, and the start location and the destination may be two locations of the plurality of locations.

As shown in FIG. 9B, route 930 may represent a route from location 910B to location 910C. Locations 921, 922, and 923 may represent locations that route 930 passes through. In some embodiments, Locations 910B and 910C may be stored in the route table as a start location and a destination of the route 930, and locations 921, 922, 923 may be stored in the route table in sequence as sequence information. When the server 110 receives similar start location and destination from the user equipment 130 and/or the driver terminal 140, by extracting the start location, destination and the sequence information, a route may be generated and displayed.

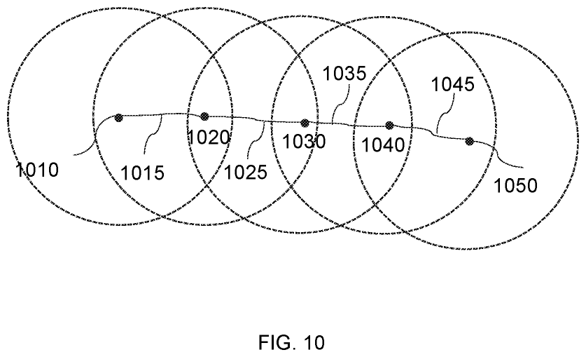

FIG. 10 is a schematic diagram illustrating an exemplary route planning according to some embodiments of the present disclosure. In some embodiments, FIG. 10 is an exemplary embodiment corresponding to the process 700.

As shown in FIG. 10, Location 1010 may be a start location and Location 1050 may be a destination. In some embodiments, start location 1010 and destination 1050 may be far from each other (e.g. not within the circle of a threshold distance). The server 110 may obtain Location 1020 within the circle of 1010 based on the start location 1010 and the destination 1050. Location 1020 may be also referred to as first location as illustrated in process 700. The server 110 may obtain Location 1030 within the circle of Location 1020 based on Locations 1020 and 1050. Similarly, the server 110 may obtain Location 1040. As Location 1040 lies within the circle of Location 1050, no extra locations are required to be generated. Then the routes (e.g., 1015, 1025, 1035, and 1045) between the adjacent locations may be generated as described elsewhere in this disclosure. The server 110 may generate a final route from the start location 1010 to the destination 1050 based on the routes between the adjacent locations. For example, a final route may be generated by connecting 1015, 1025, 1035, and 1045.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the preceding.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
a storage device storing a set of instructions; and
at least one processor configured to communicate with the storage device, wherein when executing the set of instructions, the at least one processor is configured to cause the system to:
receive information including a start location and a destination from a user equipment via a network;
access a database to obtain a table, the table including a plurality of locations and a plurality of routes; and
generate a target route from the start location to the destination based on the table.

2. The system of claim 1, wherein the table is generated according to a process of generating a table including a plurality of locations and a plurality of routes, the process comprising:
obtaining a plurality of first locations;
determining a plurality of routes relating to the plurality of first locations;
determining a plurality of second locations that each of the plurality of routes passes through; and
generating the table, wherein the table includes the plurality of first locations, the plurality of routes, and the plurality of second locations.

3. The system of claim 2, wherein the process of generating the table further comprises:
obtaining a plurality of historical orders; and
obtaining the plurality of first locations and the plurality of routes based on the historical orders.

4. The system of claim 2, wherein the determining the plurality of routes relating to the plurality of first locations comprises:
generating, based on the plurality of first locations, the plurality of routes by a route planning algorithm.

5. The system of claim 4, wherein the route planning algorithm comprises one of Dijkstra algorithm, Floyd-Warshall algorithm, or Bellman-Ford algorithm.

6. The system of claim 2, wherein the determining a plurality of routes relating to the plurality of first locations comprises:
obtaining a distance threshold;
determining a plurality of pairs of the first locations, a distance between two locations of each of the pairs of locations being less than the distance threshold;
designating first locations of at least one pair of the plurality of pairs of the first locations as a start point and an end point; and
determining the plurality of routes relating to the plurality of first locations, the plurality of routes including a route from the start point to the end point.

7. The system of claim 1, wherein the accessing the database to obtain the table comprises:
accessing the database, the database including a first table and a second table;
determining a real-time condition; and
selecting a table from the first table and the second table as the obtained table according to the real-time condition.

8. The system of claim 7, wherein the real-time condition is associated with a time of receiving the information including the start location and the destination.

9. The system of claim 7, wherein one of the first table or second tables is generated according to a process, the process comprising:
obtaining a plurality of first locations;
determining a plurality of routes relating to the plurality of first locations under a condition;
determining a plurality of second locations that the plurality of routes pass through; and
generating the table including the plurality of locations, the plurality of routes, and the plurality of second locations.

10. The system of claim 1, wherein determining the target route from the start location to the destination is generated based on characteristic information related to one or more routes of the plurality of routes, the one or more routes including the start location or the destination.

11. A method, comprising:
receiving information including a start location and a destination from a user equipment via a network;
accessing a database to obtain a table, the table including a plurality of locations and a plurality of routes; and
generating a target route from the start location to the destination based on the table.

12. The method of claim 11, wherein the table is generated according to a process of generating a table including a plurality of locations and a plurality of routes, the process comprising:
obtaining a plurality of first locations;
determining a plurality of routes relating to the plurality of first locations;
determining a plurality of second locations that each of the plurality of routes passes through; and
generating the table, wherein the table includes the plurality of first locations, the plurality of routes, and the plurality of second locations.

13. The method of claim 12, wherein the process of generating the table further comprises:
obtaining a plurality of historical orders; and
obtaining the plurality of first locations and the plurality of routes based on the historical orders.

14. The method of claim 12, wherein the determining the plurality of routes relating to the plurality of first locations comprises:
generating, based on the plurality of first locations, the plurality of routes by a route planning algorithm.

15. The method of claim 14, wherein the route planning algorithm comprises one of Dijkstra algorithm, Floyd-Warshall algorithm, or Bellman-Ford algorithm.

16. The method of claim 15, wherein the determining a plurality of routes relating to the plurality of first locations comprises:
obtaining a distance threshold;
determining a plurality of pairs of the first locations, a distance between two locations of each of the pairs of locations being less than the distance threshold;
designating first locations of at least one pair of the plurality of pairs of the first locations as a start point and an end point; and
determining the plurality of routes relating to the plurality of first locations, the plurality of routes including a route from the start point to the end point.

17. The method of claim 11, wherein the accessing the database to obtain the table comprises:
accessing the database, the database including a first table and a second table;
determining a real-time condition; and
selecting a table from the first table and the second table as the obtained table according to the real-time condition.

18. The method of claim 17, wherein one of the first table or second tables is generated according to a process, the process comprising:
obtaining a plurality of first locations;
determining a plurality of routes relating to the plurality of first locations under a condition;
determining a plurality of second locations that the plurality of routes pass through; and
generating the table including the plurality of first locations, the plurality of routes, and the plurality of second locations.

19. A non-transitory computer readable medium, comprising executable instructions that, when executed by at least one processor of an electronic device, directs the at least one processor to perform actions of:
receiving information including a start location and a destination from a user equipment via a network;
accessing a database to obtain a table, the table including a plurality of locations and a plurality of routes; and
generating a target route from the start location to the destination based on the table.

20. The method of claim 17, wherein the real-time condition is associated with a time of receiving the information including the start location and the destination.
